(19) United States
(12) Patent Application Publication
(10) Pub. No.: US 2020/0311526 A1
(43) Pub. Date: Oct. 1, 2020

(54) ACCELERATION METHOD, APPARATUS AND SYSTEM ON CHIP

(71) Applicant: HANGZHOU FABU TECHNOLOGY CO., LTD., HANGZHOU CITY (CN)

(72) Inventors: SIDDARTHA KAVILIPATI, TEMPE, AZ (US); HANG NGUYEN, TEMPE, AZ (US); YUFEI MA, TEMPE, AZ (US); JING HU, TEMPE, AZ (US)

(21) Appl. No.: 16/409,746

(22) Filed: May 10, 2019

Related U.S. Application Data
(63) Continuation of application No. PCT/CN2019/079494, filed on Mar. 25, 2019.

(51) Int. Cl. G06N 3/063; G06N 3/08; G06F 9/50

(52) U.S. Cl. CPC G06N 3/063; G06F 9/5027; G06N 3/08

(57) ABSTRACT

Provided are an acceleration method, an apparatus and a system on chip. The acceleration method includes: the accelerator receives N-th parameter information of an N-th layer from a controller, wherein M layer of the deep neural network correspond to M application specific integrated circuit in the accelerator, wherein M and N are positive integer, M≥2, 1≤N≤M, executes computation of the N-th layer according to the N-th parameter information, and transmits N-th computation result information of the N-th layer indicates that the computation of the N-th layer is completed, to the controller, wherein the computation result information comprises computation result of the N-th layer. Then a complete flexibility for ASIC implementations of hardware accelerator can be achieved, and any kind of DNN based algorithms can be supported, which improves the universality of the accelerator.

### CROSS-REFERENCE TO RELATED APPLICATIONS

This application is a continuation of International Application No. PCT/CN2019/079494, filed on Mar. 25, 2019, entitled “ACCELERATION METHOD, APPARATUS AND SYSTEM ON CHIP”, the content of which is incorporated herein by reference in its entirety.

### TECHNICAL FIELD

The present application relates to the technical field of acceleration of deep neural networks, and in particular, to an acceleration method, an apparatus and a system on chip (SoC).

### BACKGROUND

With the development of artificial intelligence (AI), some computations in AI can be completed by a variety of components disposed on SoC, for example, some computations in AI can be accelerated through the use of AI accelerator(s).

At present, deep neural networks (DNNs) run on AI accelerators, and the most popular DNN is convolution neural networks (CNNs). CNNs are a sequence of layers, stacked to form task graphs in deep learning algorithms. With advent of using deep learning algorithms for autonomous driving, CNNs are getting deeper by adding more layers to the network to improve accuracy. Each layer is a set of mathematical operations transforming one three dimensional input data to another. Each layer characteristics are defined by set of hyperparameters which are typically stored in hardware (HW) as programmable registers.

Application specific integrated circuits (ASICs) required complete knowledge of deep learning algorithms early in the design restricting flexibility of alogirthm changes during later phases of development (or post tapeout). Field-programmable gate arrays (FPGAs)/graphics processing units (GPUs) are flexible but power hungry, can only be used for training and not for large scale deployment.

This background information is provided to reveal information believed by the applicant to be of possible relevance to the present application. No admission is necessarily intended, nor should be construed, that any of the preceding information constitutes prior art against the present application.

### SUMMARY

In view of the above, in order to overcome the above problem, the present application provides a data fusion method and related products.

The foregoing and other objects are achieved by the subject matter of the independent claims. Further implementation forms are apparent from the dependent claims, the description and the figures.

A first aspect of the present application relates to an acceleration method, the method includes: receiving, by an accelerator running a deep neural network, N-th parameter information of an N-th layer from a controller, where M layer of the deep neural network correspond to M application specific integrated circuit in the accelerator, where M and N are positive integer, M≥2, 1≤N≤M; executing, by the accelerator, computation of the N-th layer according to the N-th parameter information; transmitting, by the accelerator, N-th computation result information of the N-th layer indicates that the computation of the N-th layer is completed, to the controller, where the computation result information includes computation result of the N-th layer.

A second aspect of the present application relates to an acceleration method, the method includes: generating, by a controller, N-th parameter information for an N-th layer in a deep neural network; transmitting, by the controller, the N-th parameter information to an accelerator running the deep neural network, where M layer of the deep neural network correspond to M application specific integrated circuit in the accelerator, where M and N are positive integer, M≥2, 1≤N≤M; receiving, by the controller, N-th computation result information of the N-th layer indicates that computation of the N-th layer is completed, from the accelerator, where the computation result information includes computation result of the N-th layer.

A third aspect of the present application relates to an accelerator running a deep neural network, the accelerator includes a receiving unit, an executing unit and a transmitting unit. The receiving unit is configured to receive N-th parameter information of an N-th layer from a controller, where M layer of the deep neural network correspond to M application specific integrated circuit in the accelerator, where M and N are positive integer, M≥2, 1≤N≤M. The executing unit is configured to execute computation of the N-th layer according to the N-th parameter information. The transmitting unit is configured to transmit N-th computation result information of the N-th layer indicates that the computation of the N-th layer is completed, to the controller, where the computation result information includes computation result of the N-th layer.

A fourth aspect of the present application relates to a controller, the controller includes a generating unit, a transmitting unit and a receiving unit. The generating unit is configured to generate N-th parameter information for an N-th layer in a deep neural network. The transmitting unit is configured to transmit the N-th parameter information to an accelerator running the deep neural network, where M layer of the deep neural network correspond to M application specific integrated circuit in the accelerator, where M and N are positive integer, M≥2, 1≤N≤M. The receiving unit is configured to receive N-th computation result information of the N-th layer indicates that computation of the N-th layer is completed, from the accelerator, where the computation result information includes computation result of the N-th layer.

A fifth aspect of the present application relates to an accelerator running a deep neural network, the accelerator includes an interface means and a processor means. The interface means is configured to receive N-th parameter information of an N-th layer from a controller, where M layer of the deep neural network correspond to M application specific integrated circuit in the accelerator, where M and N are positive integer, M≥2, 1≤N≤M. The processor means is configured to execute computation of the N-th layer according to the N-th parameter information. The interface means is further configured to transmit N-th computation result information of the N-th layer indicates that the computation of the N-th layer is completed, to the controller, where the computation result information includes computation result of the N-th layer.

A sixth aspect of the present application relates to a controller, the controller includes an interface means and a processor means. The processor means is configured to generate N-th parameter information for an N-th layer in a deep neural network. The interface means is configured to transmit the N-th parameter information to an accelerator running the deep neural network, where M layer of the deep neural network correspond to M application specific integrated circuit in the accelerator, where M and N are positive integer, M≥2, 1≤N≤M. The interface means is further configured to receive N-th computation result information of the N-th layer indicates that computation of the N-th layer is completed, from the accelerator, where the computation result information includes computation result of the N-th layer.

A seventh aspect of the present application relates to a system on chip, the system on chip includes the accelerator according to third aspect or fifth aspect and the controller according to the fourth aspect or the sixth aspect.

With the acceleration method, the apparatus and the system on chip provided in the present application, a complete flexibility for ASIC implementations of hardware accelerator can be achieved, and any kind of DNN based algorithms can be supported, which improves the universality of the accelerator.

### BRIEF DESCRIPTION OF DRAWINGS

The accompanying drawings are used to provide a further understanding of the present application, constitute a part of the specification, and are used to explain the present application together with the following specific embodiments, but should not be construed as limiting the present application.

FIG. 1 is a schematic view of a deep learning accelerator (DLA);

FIG. 2 is a schematic flowchart of a first acceleration method according to an embodiment of the present application;

FIG. 3 is a schematic flowchart of a second acceleration method according to an embodiment of the present application;

FIG. 4 is a schematic flowchart of a third acceleration method according to an embodiment of the present application;

FIG. 5 is a schematic flowchart of a fourth acceleration method according to an embodiment of the present application;

FIG. 6 is a schematic flowchart of a fifth acceleration method according to an embodiment of the present application;

FIG. 7 is a structural view of a first accelerator running a deep neural network according to an embodiment of the present application;

FIG. 8 is a structural view of a first controller according to an embodiment of the present application;

FIG. 9 is a structural view of a second controller according to an embodiment of the present application;

FIG. 10 is a structural view of a second accelerator according to an embodiment of the present application;

FIG. 11 is a structural view of a third controller according to an embodiment of the present application; and

FIG. 12 is a structural view of a system on chip 1200 according to an embodiment of the present application.

### DESCRIPTION OF EMBODIMENTS

In the following description, reference is made to the accompanying figures, which form part of the disclosure, and which show, by way of illustration, specific aspects of embodiments of the present application or specific aspects in which embodiments of the present application may be used. It is understood that embodiments of the present application may be used in other aspects and include structural or logical changes not depicted in the figures. The following detailed description, therefore, is not to be taken in a limiting sense, and the scope of the present application is defined by the appended claims.

For instance, it is understood that a disclosure in connection with a described method may also hold true for a corresponding device or system configured to perform the method and vice versa. For example, if one or a plurality of specific method steps are described, a corresponding device may include one or a plurality of units, e.g. functional units, to perform the described one or plurality of method steps (e.g. one unit performing the one or plurality of steps, or a plurality of units each performing one or more of the plurality of steps), even if such one or more units are not explicitly described or illustrated in the figures. On the other hand, for example, if a specific apparatus is described based on one or a plurality of units, e.g. functional units, a corresponding method may include one step to perform the functionality of the one or plurality of units (e.g. one step performing the functionality of the one or plurality of units, or a plurality of steps each performing the functionality of one or more of the plurality of units), even if such one or plurality of steps are not explicitly described or illustrated in the figures. Further, it is understood that the features of the various exemplary embodiments and/or aspects described herein may be combined with each other, unless specifically noted otherwise.

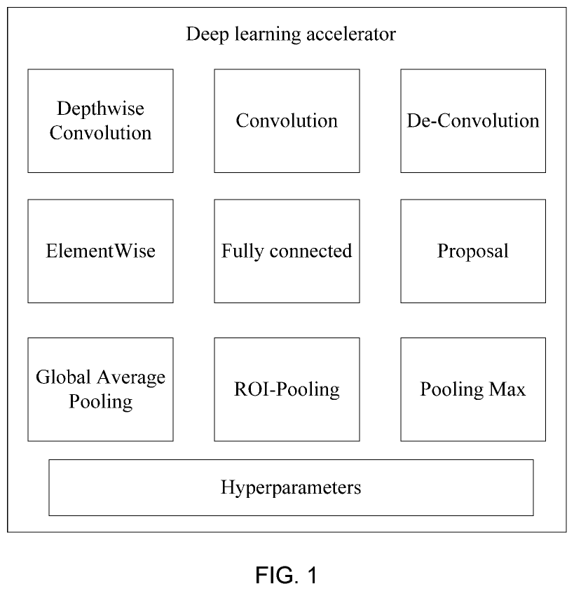

FIG. 1 is a schematic view of a DLA, as shown in FIG. 1, DLA consists of hardware primitive blocks as shown in FIG. 1, the hardware primitive blocks sharing HW resources like multiplier and accumulator (MAC) units, memory buffers, adders etc. The DLA implements a DNN graph on the hardware primitive blocks. DNN graph is a combination of multiple layers (like convolution, pooling-max, fully connected etc.), hardware implements these hardware primitives and a global control logic implements a state machine to execute the graphs based on programmable registers which stores the graph information called hyperparameters representing inputs for each layer, behavior of the layers like stride, padding, apply RELU/Bias settings etc.

In the design of the DLA provided in the present application, each primitive shown in FIG. 1 is a neural network layer that can be individually programmed to build the entire graph. Each of the primitive blocks as shown in FIG. 1 corresponds to an ASIC. That is, hardware implements each primitive block as shown in FIG. 1 is an ASIC. DLA algorithms need to be executed sequentially as they are dependent on activations from previous layers, so only one primitive is active at a time and can be activated by a set of programmable registers holding network information called hyperparameters. Therefore, for the architecture that hardware implements each primitive block as shown in FIG. 1 is an ASIC, a controller is provided on a system on chip along with the DLA, the controller can be a CPU co-processor typically FPU supported ARM core like A53 which has compiler to calculate hyperparameters required for each layer from the network graphs and activates the hardware primitives in the accelerator using programmable registers, where the compiler can be a C based network, which is not limited in any one of the embodiments of the present application unless otherwise specified.

It should be noted that the controller can be either a CPU that has already existing on the system on chip, and further configured to calculate hyperparameters required for each layer from the network graphs and activates the hardware primitives in the accelerator, or a newly added CPU to calculate hyperparameters required for each layer from the network graphs and activates the hardware primitives in the accelerator, which is not limited in any one of the embodiments of the present application unless otherwise specified.

Based on the design and configuration cited above, the present application breaks the dependency of knowing algorithms early in the design allowing ASICs to have scalability of FPGAs and performance of GPUs while bringing advantages of low power and area from ASICs. The design and configuration cited above gives complete flexibility for ASIC implementations of hardware accelerators and has the advantage of supporting any DNN based algorithms (with the primitive blocks), without any knowledge of network graphs early in the design.

Following will describe the design, configuration and the interaction between an accelerator and a controller in detail to more clearly introduce the technical solution of the present application.

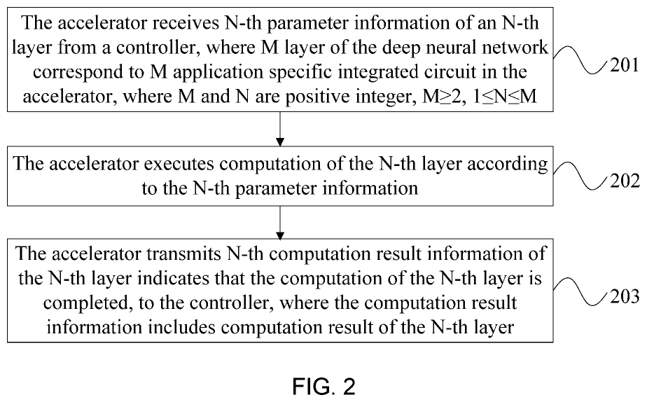

FIG. 2 is a schematic flowchart of a first acceleration method according to an embodiment of the present application. This method shows the method executed by an accelerator running a DNN. It should be noted that the DNN can be any deep neural network, such as CNN, which is not limited in any one of the embodiments of the present application unless otherwise specified.

As shown in FIG. 2, the method includes the following steps:

S201: the accelerator receives N-th parameter information of an N-th layer from a controller, where M layer of the deep neural network correspond to M application specific integrated circuit in the accelerator, where M and N are positive integer, M≥2, 1≤N≤M.

For example, if there are 16 layers in a DNN, there would be 16 ASICs in the accelerator. During implementation of the DNN by the accelerator, the 16 layers are executed sequentially from the first layer to the sixteenth layer.

S202: the accelerator executes computation of the N-th layer according to the N-th parameter information.

In one possible implementation, the parameter information includes tiling information, kernel sizes, padding sizes, bias and rectified linear unit (ReLu) settings. Once the accelerator receives the N-th parameter information of the N-th layer from the controller, the accelerator executes computation of the N-th layer according to the N-th parameter information.

S203: the accelerator transmits N-th computation result information of the N-th layer indicates that the computation of the N-th layer is completed, to the controller, where the computation result information includes computation result of the N-th layer.

Specifically, after the computation of the N-th layer is completed, the accelerator transmits N-th computation result information of the N-th layer indicates that the computation of the N-th layer is completed, and the computation result of the N-th layer is included in the N-th computation result information. The computation result may include the parameters for the next layer.

The present application provides an acceleration method, where the accelerator receives N-th parameter information of an N-th layer from a controller, where M layer of the deep neural network correspond to M application specific integrated circuit in the accelerator, where M and N are positive integer, M≥2, 1≤N≤M, executes computation of the N-th layer according to the N-th parameter information and transmits N-th computation result information of the N-th layer indicates that the computation of the N-th layer is completed, to the controller, where the computation result information includes computation result of the N-th layer. Then a complete flexibility for ASIC implementations of hardware accelerator can be achieved, and any kind of DNN based algorithms can be supported, which improves the universality of the accelerator.

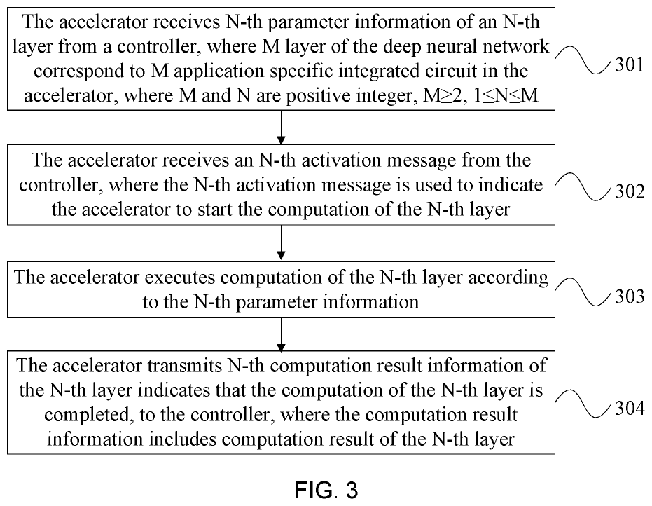

FIG. 3 is a schematic flowchart of a second acceleration method according to an embodiment of the present application. This method is executed by the accelerator.

As shown in FIG. 3, the method includes the following steps:

S301: the accelerator receives N-th parameter information of an N-th layer from a controller, where M layer of the deep neural network correspond to M application specific integrated circuit in the accelerator, where M and N are positive integer, M≥2, 1≤N≤M.

S302: the accelerator receives an N-th activation message from the controller, where the N-th activation message is used to indicate the accelerator to start the computation of the N-th layer.

S303: the accelerator executes computation of the N-th layer according to the N-th parameter information.

S304: the accelerator transmits N-th computation result information of the N-th layer indicates that the computation of the N-th layer is completed, to the controller, where the computation result information includes computation result of the N-th layer.

In this embodiment, the computation of the N-th layer is activated by the N-th activation message from the controller, which increases the reliability of the computation of the N-th layer.

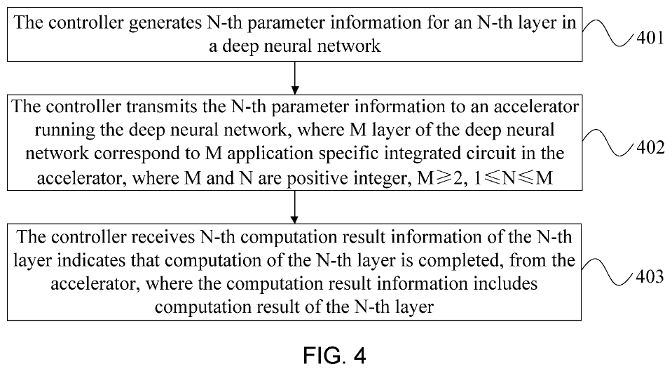

FIG. 4 is a schematic flowchart of a third acceleration method according to an embodiment of the present application. This method is executed by the controller.

As shown in FIG. 4, the method includes the following steps:

S401: the controller generates N-th parameter information for an N-th layer in a deep neural network.

S402: the controller transmits the N-th parameter information to an accelerator running the deep neural network, where M layer of the deep neural network correspond to M application specific integrated circuit in the accelerator, where M and N are positive integer, M

S403: the controller receives N-th computation result information of the N-th layer indicates that computation of the N-th layer is completed, from the accelerator, where the computation result information includes computation result of the N-th layer.

In one possible implementation, the parameter information includes tiling information, kernel sizes, padding sizes, bias and rectified linear unit (ReLu) settings.

The present application provides an acceleration method, where the controller generates N-th parameter information for an N-th layer in a deep neural network, transmits the N-th parameter information to an accelerator running the deep neural network, where M layer of the deep neural network correspond to M application specific integrated circuit in the accelerator, where M and N are positive integer, M≥2, 1≤N≤M, and receives N-th computation result information of the N-th layer indicates that computation of the N-th layer is completed, from the accelerator, where the computation result information includes computation result of the N-th layer. Then a complete flexibility for ASIC implementations of hardware accelerator can be achieved, and any kind of DNN based algorithms can be supported, which improves the universality of the accelerator.

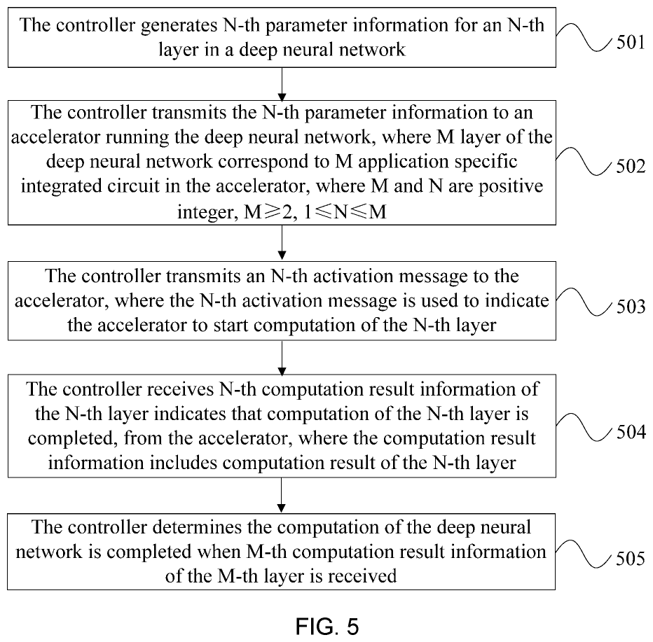

FIG. 5 is a schematic flowchart of a fourth acceleration method according to an embodiment of the present application. This method is executed by the controller.

As shown in FIG. 5, the method includes the following steps:

S501: the controller generates N-th parameter information for an N-th layer in a deep neural network.

In one possible implementation, N>2, S501 includes: the controller generates N-th parameter information for the N-th layer according to computation result of the N-1-th layer.

Due to the characteristic of DNN, when execution of a layer of the DNN is based on the computed result of a previous layer of the current layer, except for the first layer.

S502: the controller transmits the N-th parameter information to an accelerator running the deep neural network, where M layer of the deep neural network correspond to M application specific integrated circuit in the accelerator, where M and N are positive integer, M

S503: the controller transmits an N-th activation message to the accelerator, where the N-th activation message is used to indicate the accelerator to start computation of the N-th layer.

S504: the controller receives N-th computation result information of the N-th layer indicates that computation of the N-th layer is completed, from the accelerator, where the computation result information includes computation result of the N-th layer.

S505: the controller determines the computation of the deep neural network is completed when M-th computation result information of the M-th layer is received.

With the embodiment illustrated in FIG. 5, a complete flexibility for ASIC implementations of hardware accelerator can be achieved, and any kind of DNN based algorithms can be supported, which improves the universality of the accelerator.

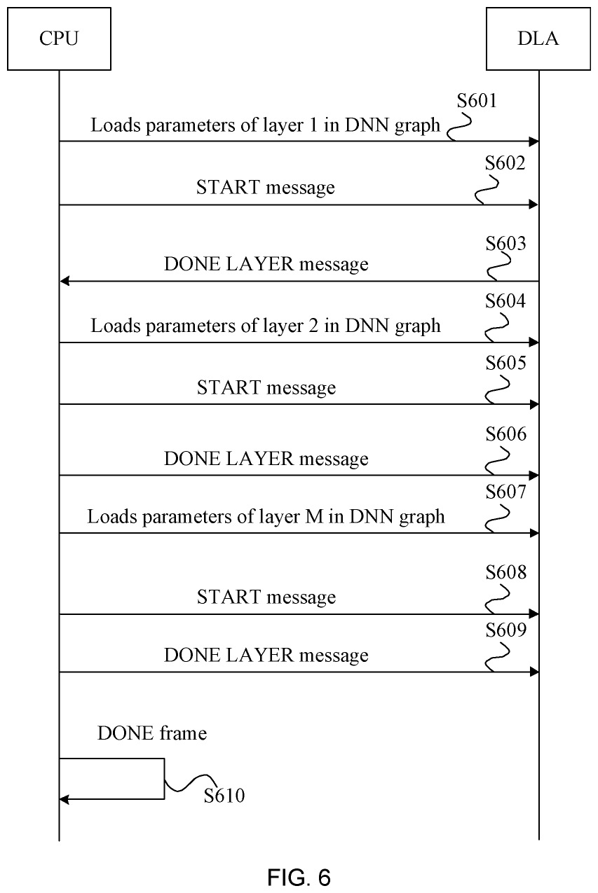

FIG. 6 is a schematic flowchart of a fifth acceleration method according to an embodiment of the present application. Following will describe an example scenario where the accelerator is an AI accelerator running DNN (such as DLA), and the controller is a CPU in conjunction with FIG. 6.

The method includes the following steps:

S601: the CPU loads parameters of layer 1 in DNN graph to the DLA.

S602: the CPU transmits a START message to the DLA.

The START message is used to indicate the accelerator to start the computation of the layer 1.

s603: the DLA transmits DONE LAYER message to the CPU.

The DONE LAYER message indicates that the computation of the layer 1 is completed, and the computation result of the layer 1 is included in the DONE LAYER message.

S604: the CPU loads parameters of layer 2 in DNN graph to the DLA.

S605: the CPU transmits a START message to the DLA.

The START message is used to indicate the accelerator to start the computation of the layer 2.

S606: the DLA transmits DONE LAYER message to the CPU.

The DONE LAYER message indicates that the computation of the layer 2 is completed, and the computation result of the layer 2 is included in the DONE LAYER message.

S607: the CPU loads parameters of layer M in DNN graph to the DLA.

S608: the CPU transmits a START message to the DLA.

The START message is used to indicate the accelerator to start the computation of the layer M.

S609: the DLA transmits DONE LAYER message to the CPU.

The DONE LAYER message indicates that the computation of the layer M is completed, and the computation result of the layer M is included in the DONE LAYER message.

S610: the CPU determines the computation of the deep neural network is completed.

With the embodiment illustrated in FIG. 6, a complete flexibility for ASIC implementations of hardware accelerator can be achieved, and any kind of DNN based algorithms can be supported, which improves the universality of the accelerator.

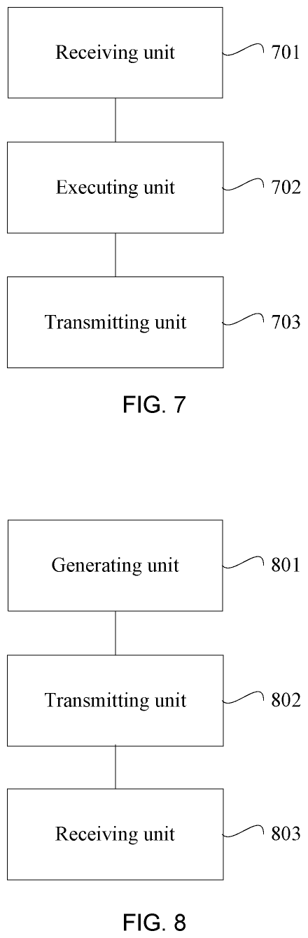

FIG. 7 is a structural view of a first accelerator running a deep neural network according to an embodiment of the present application, as shown in FIG. 7, where the accelerator includes: a receiving unit 701, an executing unit 702, and a transmitting unit 703.

The receiving unit 701 is configured to receive N-th parameter information of an N-th layer from a controller, where M layer of the deep neural network correspond to M application specific integrated circuit in the accelerator, where M and N are positive integer, M≥2, 1≤N≤M.

The executing unit 702 is configured to execute computation of the N-th layer according to the N-th parameter information.

The transmitting unit 703 is configured to transmit N-th computation result information of the N-th layer indicates that the computation of the N-th layer is completed, to the controller, where the computation result information includes computation result of the N-th layer.

The present application provides an accelerator running a deep neural network, the receiving unit 701 is configured to receive N-th parameter information of an N-th layer from a controller, where M layer of the deep neural network correspond to M application specific integrated circuit in the accelerator, where M and N are positive integer, M≥2, 1≤N≤M, the executing unit 702 is configured to execute computation of the N-th layer according to the N-th parameter information, and the transmitting unit 703 is configured to transmit N-th computation result information of the N-th layer indicates that the computation of the N-th layer is completed, to the controller, where the computation result information includes computation result of the N-th layer. Then a complete flexibility for ASIC implementations of hardware accelerator can be achieved, and any kind of DNN based algorithms can be supported, which improves the universality of the accelerator.

In one possible implementation, the receiving unit 701 is further configured to receive an N-th activation message from the controller before the executing unit 702 executes the computation of the N-th layer, where the N-th activation message is used to indicate the accelerator to start the computation of the N-th layer.

In one possible implementation, the parameter information includes tiling information, kernel sizes, padding sizes, bias and rectified linear unit (ReLu) settings.

FIG. 8 is a structural view of a first controller according to an embodiment of the present application, as shown in FIG. 8, the controller includes: a generating unit 801, a transmitting unit 802, and a receiving unit 803.

The generating unit 801 is configured to generate N-th parameter information for an N-th layer in a deep neural network.

In an embodiment, the generating unit 801 can be a compiler implemented by the controller.

The transmitting unit 802 is configured to transmit the N-th parameter information to an accelerator running the deep neural network, where M layer of the deep neural network correspond to M application specific integrated circuit in the accelerator, where M and N are positive integer, M≥2, 1≤N≤M.

The receiving unit 803 is configured to receive N-th computation result information of the N-th layer indicates that computation of the N-th layer is completed, from the accelerator, where the computation result information includes computation result of the N-th layer.

In one possible implementation, the transmitting unit 802 is further configured to transmit an N-th activation message to the accelerator after transmit the N-th parameter information to the accelerator, where the N-th activation message is used to indicate the accelerator to start computation of the N-th layer.

In one possible implementation, the parameter information includes tiling information, kernel sizes, padding sizes, bias and rectified linear unit (ReLu) settings.

In one possible implementation, N2, and the generating unit 801 is further configured to generate N-th parameter information for the N-th layer according to computation result of the N-1-th layer.

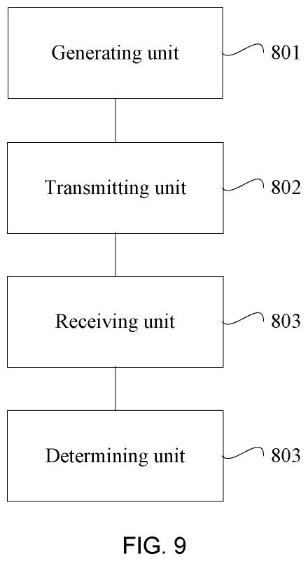

FIG. 9 is a structural view of a second controller according to an embodiment of the present application, as shown in FIG. 9, based on FIG. 8, the controller further includes a determining unit 804, the determining unit 804 is configured to determine the computation of the deep neural network is completed when M-th computation result information of the M-th layer is received by the receiving unit 803.

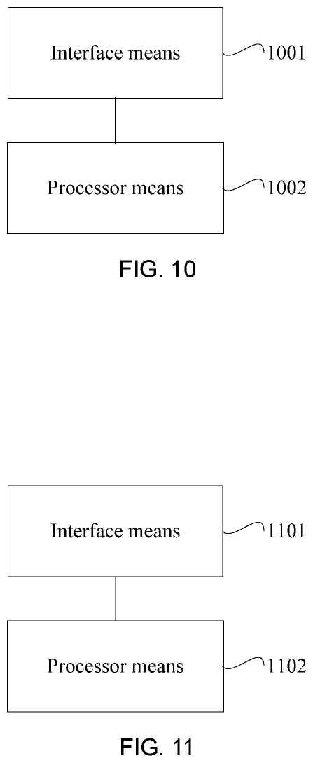

FIG. 10 is a structural view of a second accelerator according to an embodiment of the present application, as shown in FIG. 10, where the accelerator includes: an interface means 1001 and a processor means 1002.

The interface means 1001 is configured to receive N-th parameter information of an N-th layer from a controller, where M layer of the deep neural network correspond to M application specific integrated circuit in the accelerator, where M and N are positive integer, M≥2, 1≤N≤M;

The processor means 1002 is configured to execute computation of the N-th layer according to the N-th parameter information;

The interface means 1001 is further configured to transmit N-th computation result information of the N-th layer indicates that the computation of the N-th layer is completed, to the controller, where the computation result information includes computation result of the N-th layer.

In one possible implementation, the interface means 1001 is further configured to receive an N-th activation message from the controller before the processor means 1002 executes the computation of the N-th layer, where the N-th activation message is used to indicate the accelerator to start the computation of the N-th layer.

In one possible implementation, the parameter information includes tiling information, kernel sizes, padding sizes, bias and rectified linear unit (ReLu) settings.

FIG. 11 is a structural view of a third controller according to an embodiment of the present application, as shown in FIG. 11, where the controller includes: an interface means 1101 and a processor means 1102.

The processor means 1102 is configured to generate N-th parameter information for an N-th layer in a deep neural network.

The interface means 1101 is configured to transmit the N-th parameter information to an accelerator running the deep neural network, where M layer of the deep neural network correspond to M application specific integrated circuit in the accelerator, where M and N are positive integer, M≥2, 1≤N≤M.

The interface means 1101 is further configured to receive N-th computation result information of the N-th layer indicates that computation of the N-th layer is completed, from the accelerator, where the computation result information includes computation result of the N-th layer.

In one possible implementation, the interface means 1101 is further configured to transmit an N-th activation message to the accelerator after transmit the N-th parameter information to the accelerator, where the N-th activation message is used to indicate the accelerator to start computation of the N-th layer.

In one possible implementation, the parameter information includes tiling information, kernel sizes, padding sizes, bias and rectified linear unit (ReLu) settings.

In one possible implementation, N≥2, and the processor means 1102 is further configured to generate N-th parameter information for the N-th layer according to computation result of the N-1-th layer.

In one possible implementation, the processor means 1102 is further configured to determine the computation of the deep neural network is completed when M-th computation result information of the M-th layer is received by the interface means 1101.

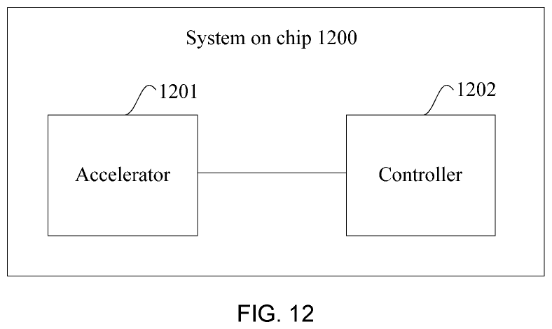

FIG. 12 is a structural view of a system on chip 1200 according to an embodiment of the present application, as shown in FIG. 12, the system on chip includes: an accelerator 1201 and a controller 1202. The accelerator can be any of the accelerator cited above, and the controller can be any of the controller cited above.

Terms such as “first”, “second” and the like in the specification and claims of the present application as well as in the above drawings are intended to distinguish different objects, but not intended to define a particular order.

The term such as “and/or” in the embodiments of the present application is merely used to describe an association between associated objects, which indicates that there may be three relationships, for example, A and/or B may indicate presence of A only, of both A and B, and of B only.

The term “a” or “an” is not intended to specify one or a single element, instead, it may be used to represent a plurality of elements where appropriate.

It will be further understood that the terms “including”, “including”, having” and variants thereof, when used in this specification, specify the presence of stated features, steps, operations, elements, and/or components, but do not preclude the presence or addition of one or more other features, steps, operations, elements, components, and/or groups thereof. In contrast, the term “consisting of” when used in this specification, specifies the stated features, steps, operations, elements, and/or components, and precludes additional features, steps, operations, elements and/or components.

In the embodiments of the present application, expressions such as “exemplary” or “for example” are used to indicate illustration of an example or an instance. In the embodiments of the present application, any embodiment or design scheme described as “exemplary” or “for example” should not be interpreted as preferred or advantageous over other embodiments or design schemes. In particular, the use of “exemplary” or “for example” is aimed at presenting related concepts in a specific manner.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise a random access memory (RAM), a read-only memory (ROM), an electrically erasable programmable ROM (EEPROM), a compact disc ROM (CD-ROM) or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of inter-operative hardware units, including one or more processors as described above, in conjunction with suitable software and/or firmware.

It will be understood that, when an element or component is referred to herein as “connected to” or “coupled to” another element or component, it can be connected or coupled to the other element or component, or intervening elements or components may also be present. In contrast, when an element or component is referred to as being “directly connected to,” or “directly coupled to” another element or component, there are no intervening elements or components present between them.

While the present invention is described herein with reference to illustrative embodiments, this description is not intended to be construed in a limiting sense. Rather, the purpose of the illustrative embodiments is to make the spirit of the present invention be better understood by those skilled in the art. In order not to obscure the scope of the invention, many details of well-known processes and manufacturing techniques are omitted. Various modifications of the illustrative embodiments, as well as other embodiments, will be apparent to those of skill in the art upon reference to the description. It is therefore intended that the appended claims encompass any such modifications.

Furthermore, some of the features of the preferred embodiments of the present invention could be used to advantage without the corresponding use of other features. As such, the foregoing description should be considered as merely illustrative of the principles of the invention, and not in limitation thereof. Those of skill in the art will appreciate variations of the above-described embodiments that fall within the scope of the invention. As a result, the invention is not limited to the specific embodiments and illustrations discussed above, but by the following claims and their equivalents.

What is claimed is:

1. An acceleration method, the method comprising:
receiving, by an accelerator running a deep neural network, N-th parameter information of an N-th layer from a controller, wherein M layer of the deep neural network correspond to M application specific integrated circuit in the accelerator, wherein M and N are positive integer, M≥2, 1≤N≤M;
executing, by the accelerator, computation of the N-th layer according to the N-th parameter information;
transmitting, by the accelerator, N-th computation result information of the N-th layer indicates that the computation of the N-th layer is completed, to the controller, wherein the computation result information comprises computation result of the N-th layer.

2. The method according to claim 1, wherein before the executing, by the accelerator, computation of the N-th layer according to the N-th parameter information, the method further comprises:
receiving, by the accelerator, an N-th activation message from the controller, wherein the N-th activation message is used to indicate the accelerator to start the computation of the N-th layer.

3. The method according to claim 1, wherein the parameter information comprises tiling information, kernel sizes, padding sizes, bias and rectified linear unit (ReLu) settings.

4. An acceleration method, comprising:
generating, by a controller, N-th parameter information for an N-th layer in a deep neural network;
transmitting, by the controller, the N-th parameter information to an accelerator running the deep neural network, wherein M layer of the deep neural network correspond to M application specific integrated circuit in the accelerator, wherein M and N are positive integer, M≥2, 1≤N≤M;
receiving, by the controller, N-th computation result information of the N-th layer indicates that computation of the N-th layer is completed, from the accelerator, wherein the computation result information comprises computation result of the N-th layer.

5. The method according to claim 4, wherein after the transmitting, by a controller, the N-th parameter information to the accelerator, the method further comprising:
transmitting, by the controller, an N-th activation message to the accelerator, wherein the N-th activation message is used to indicate the accelerator to start computation of the N-th layer.

6. The method according to claim 4, wherein the parameter information comprises tiling information, kernel sizes, padding sizes, bias and rectified linear unit (ReLu) settings.

7. The method according to claim 4, wherein N≥2, and the generating, by a controller, N-th parameter information to an accelerator running a deep neural network, comprises:
generating, by the controller, N-th parameter information for the N-th layer according to computation result of the N-1-th layer.

8. The method according to claim 4, further comprising:
determining, by the controller, the computation of the deep neural network is completed when M-th computation result information of the M-th layer is received.

9. An accelerator running a deep neural network, comprising an interface means and a processor means:
the interface means is configured to receive N-th parameter information of an N-th layer from a controller, wherein M layer of the deep neural network correspond to M application specific integrated circuit in the accelerator, wherein M and N are positive integer, M≥2, 1≤N≤M;
the processor means is configured to execute computation of the N-th layer according to the N-th parameter information;
the interface means is further configured to transmit N-th computation result information of the N-th layer indicates that the computation of the N-th layer is completed, to the controller, wherein the computation result information comprises computation result of the N-th layer.

10. The accelerator according to claim 9, the interface means is further configured to receive an N-th activation message from the controller before the processor means executes the computation of the N-th layer, wherein the N-th activation message is used to indicate the accelerator to start the computation of the N-th layer.

11. The accelerator according to claim 9, wherein the parameter information comprises tiling information, kernel sizes, padding sizes, bias and rectified linear unit (ReLu) settings.
